(19) United States
(12) Patent Application Publication
(10) Pub. No.: US 2012/0219161 A1
(43) Pub. Date: Aug. 30, 2012

(54) PLAYBACK APPARATUS, AUDIO DATA CORRECTION APPARATUS AND PLAYBACK METHOD

(76) Inventors: Tadashi Amada, Ome-shi (JP); Toshifumi Yamamoto, Hino-shi (JP); Kazuyuki Saito, Ome-shi (JP)

(21) Appl. No.: 13/294,479

(22) Filed: Nov. 11, 2011

(30) Foreign Application Priority Data
Feb. 28, 2011 (JP) 2011-042625

(51) Int. Cl. H04R 1/10

(52) U.S. Cl. 381/74

(57) ABSTRACT

According to one embodiment, a playback apparatus includes a generator, a corrector, and an audio signal output module. The generator is configured to generate correction data used for correcting a frequency characteristic of sound output from a headphone based on first data and second data, the first data indicating the frequency characteristic of sound output from the headphone, and the second data indicating a target frequency characteristic. The corrector is configured to correct audio data based on the correction data. The audio signal output module is configured to output an audio signal based on the corrected audio data to the headphone.

### CROSS-REFERENCE TO RELATED APPLICATIONS

This application is based upon and claims the benefit of priority from prior Japanese Patent Application No. 2011-042625, filed Feb. 28, 2011, the entire contents of which are incorporated herein by reference.

### FIELD

Embodiments described herein relate generally to a playback apparatus, audio data correction apparatus and playback method that correct sound output from a headphone.

### BACKGROUND

In an environment in which sounds are not produced from a speaker in the open air or the like when music is played back, the user listens to the music by use of a headphone such as an earphone or stereo phone.

The frequency characteristics of sounds output from headphones are different depending on the products and sound output from the headphone may not have frequency characteristics desired by the user in some cases.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing one example of the outer appearance of a playback apparatus of a first embodiment.

FIG. 2 is an exemplary block diagram showing one example of the system configuration of the playback apparatus of the first embodiment.

FIG. 3 is an exemplary block diagram showing one example of the configuration for measuring the frequency characteristic of an earphone of a media player in the first embodiment.

FIG. 4 is an exemplary view showing one example of the configuration of an adapter in the first embodiment.

FIG. 5 is an exemplary view showing one example of the configuration of an adapter in the first embodiment.

FIG. 6 is an exemplary view showing one example of the configuration of an adapter in the first embodiment.

FIG. 7 is an exemplary diagram showing the frequency characteristic of sound output from an earphone and acquired by means of a microphone via an adapter.

FIG. 8 is an exemplary block diagram showing one example of the configuration of the correction function of a media player.

FIG. 9 is an exemplary diagram showing one example of the frequency characteristic indicated by target characteristic data.

FIG. 10 is an exemplary diagram showing one example of the frequency characteristic indicated by a designed correction filter.

FIG. 11 is a diagram showing the frequency characteristic of sound output from an earphone.

FIG. 12 is an exemplary flowchart showing one example of a process for measuring the frequency characteristic of sound output from an earphone and correcting sound output from the earphone based on measured frequency characteristic.

FIG. 13 is an exemplary block diagram showing one example of the configuration of a playback apparatus of a second embodiment.

FIG. 14 is an exemplary view showing one example of the configuration of an adapter of a third embodiment.

FIG. 15 is an exemplary block diagram showing one example of the configuration for measuring the frequency characteristic of an earphone of a media player of the third embodiment.

FIG. 16 is an exemplary diagram showing one example in which output sound from the earphone is directly acquired by means of a microphone.

FIG. 17 is an exemplary view showing one example in which a space corresponding to the adapter of the first embodiment is provided in a display unit.

FIG. 18 is an exemplary view showing one example in which a space corresponding to the adapter of the first embodiment is provided in a display unit.

FIG. 19 is an exemplary block diagram showing one example of the configuration of a correction function of a media player of a fifth embodiment.

### DETAILED DESCRIPTION

Various embodiments will be described hereinafter with reference to the accompanying drawings.

In general, according to one embodiment, a playback apparatus comprises a generator, a corrector, and an audio signal output module. The generator is configured to generate correction data used for correcting a frequency characteristic of sound output from a headphone based on first data and second data, the first data indicating the frequency characteristic of sound output from the headphone, and the second data indicating a target frequency characteristic. The corrector is configured to correct audio data based on the correction data. The audio signal output module is configured to output an audio signal based on the corrected audio data to the headphone.

### First Embodiment

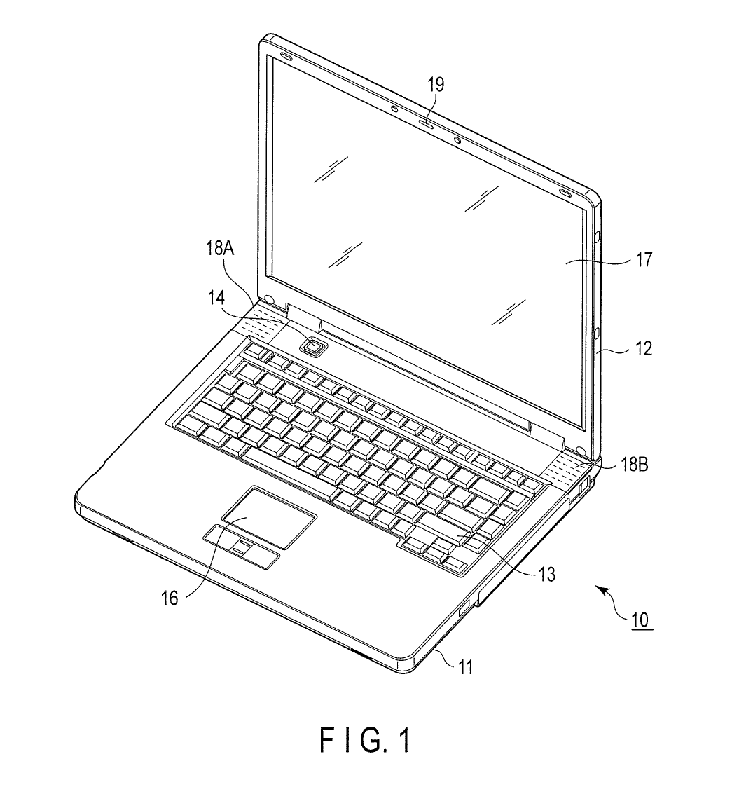

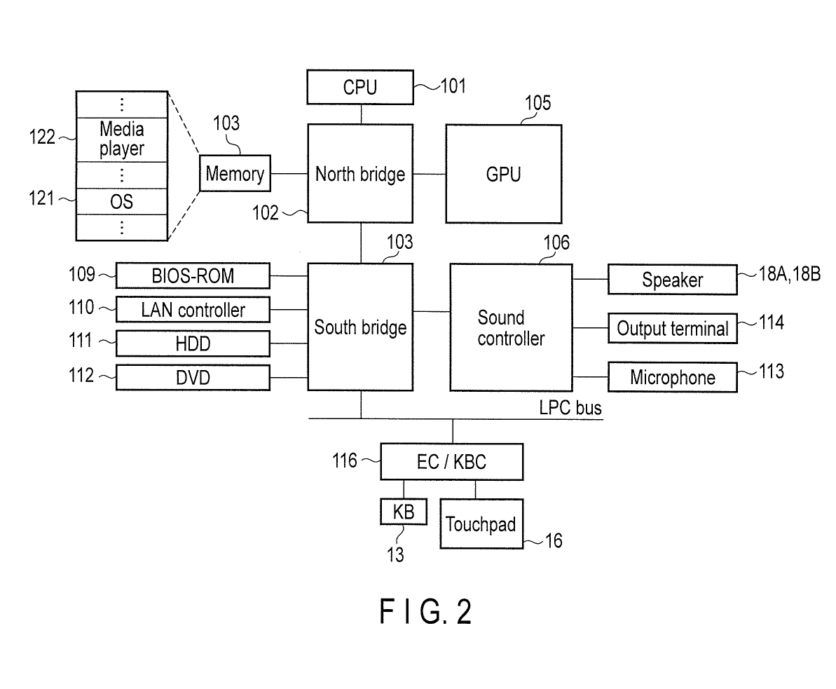

First, the configuration of a playback apparatus according to a first embodiment is explained with reference to FIG. 1 and FIG. 2. The playback apparatus of this embodiment is realized by a notebook mobile personal computer 10, for example.

FIG. 1 is a perspective view showing the state in which a display unit of the computer 10 is opened. The computer 10 includes a computer main body 11 and display unit 12. In the display unit 12, a display panel 17 including a liquid crystal panel is incorporated. Further, in the display unit 12, a microphone is provided. In the display unit 12, a microphone hole 19 used for causing the microphone to efficiently collect sounds is provided.

The display unit 12 is mounted on the computer main body 11 to freely rotate between the open position in which the upper surface of the computer main body 11 is exposed and the closed position in which the upper surface of the computer main body 11 is covered. The computer main body 11 has a thin box-shaped casing and a keyboard 13, a power button 14 for turning on/off the power source of the computer 10, a touchpad 16, speakers 18A, 18B and the like are arranged on the upper surface thereof.

Next, the system configuration of the computer 10 is explained with reference to FIG. 2.

As shown in FIG. 2, the computer 10 includes a CPU 101, north bridge 102, main memory 103, south bridge 104, graphics processing unit (GPU) 105, video memory (VRAM), sound controller 106, BIOS-ROM 109, LAN controller 110, hard disk drive (HDD) 111, DVD drive 112, embedded controller/keyboard controller IC (EC/KBC) 116 and the like.

The CPU 101 is a processor that controls the operation of the computer 10 and executes an operating system (OS) 121 loaded from the hard disk drive (HDD) 111 to the main memory 103 and various application programs such as a media player 122. The media player 122 is application software for playing back files of moving pictures (video images) and sound. The CPU 101 also executes a Basic Input/Output System (BIOS) stored in the BIOS-ROM 109. The BIOS is a program for hardware control.

The north bridge 102 is a bridge device that connects the local bus of the CPU 101 to the south bridge 104. In the north bridge 102, a memory controller that controls access to the main memory 103 is contained. Further, the north bridge 102 has a function of making communication with the GPU 105 via a serial bus of PCI EXPRESS standard.

The GPU 105 is a display controller that controls a liquid crystal panel 171 used as a display monitor of the computer 10. The GPU 105 uses the VRAM as a work memory. A video signal created by the GPU 105 is transmitted to the liquid crystal panel 171.

The south bridge 104 controls various devices on a Low Pin Count (LPC) bus and various devices on a Peripheral Component Interconnect (PCI) bus. Further, the south bridge 104 contains an Integrated Drive Electronics (IDE) controller that controls the hard disk drive (HDD) 111 and DVD drive 112. Additionally, the south bridge 104 has a function of making communication with the sound controller 106. The sound controller 106 is a sound source device and includes a circuit of a digital-to-analog converter that converts a digital signal to an electrical signal and an amplifier that amplifies the electrical signal to output to-be-played-back audio data to the speakers 18A and 18B. Further, the sound controller 106 includes a circuit of an analog-to-digital converter that converts an electrical signal input from the microphone 113 to a digital signal.

The embedded controller/keyboard controller IC (EC/KBC) 116 is a one-chip microcomputer in which an embedded controller for power control and a keyboard controller used for controlling the keyboard (KB) 13 and touchpad 16 are integrated. The embedded controller/keyboard controller IC (EC/KBC) 116 has a function of turning on/off the power source of the computer 10 in response to the operation of the power button 14 by the user.

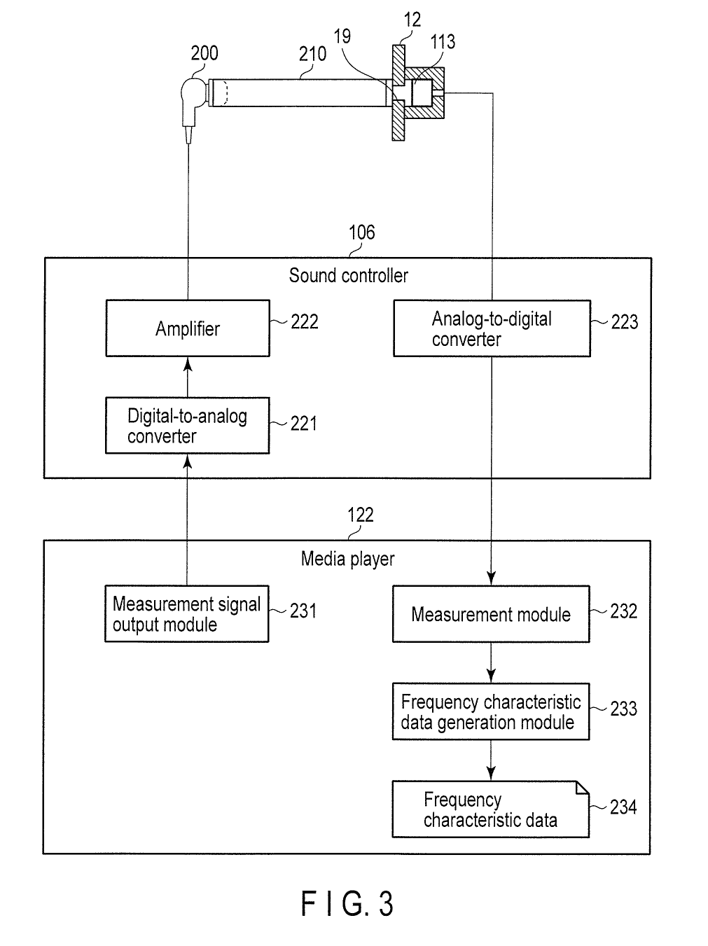

Next, the function of the media player 122 is explained. The media player 122 has a function of measuring the frequency characteristics of sound output from an earphone. The configuration for measuring the frequency characteristics of the earphone is explained with reference to FIG. 3.

The media player 122 includes a measurement signal output module 231, measurement module 232, frequency characteristic data generation module 233 and the like. The measurement signal output module 231 generates a measurement signal for measurement and outputs a thus generated measurement signal to a digital-to-analog converter. For example, the measurement signal is white noise, pink noise, a unit pulse of preset width or less or a time-stretched pulse (TSP) signal.

Further, the sound controller 106 includes a digital-to-analog converter (digital-to-analog conversion circuit) 221, amplifier 222, analog-to-digital converter (analog-to-digital conversion circuit) 223 and the like.

A reference signal is converted to an electrical signal by means of the digital-to-analog converter 221. The thus converted electrical signal is amplified by the amplifier 222 and the amplified electrical signal is input to an earphone 200. The earphone 200 outputs sound corresponding to the input signal. Sound output from the earphone 200 is input to the microphone 113 via an adapter 210. The microphone 113 converts the input sound to an electrical signal and outputs the electrical signal to the analog-to-digital converter 223. The analog-to-digital converter 223 converts the electrical signal to a digital signal and outputs the digital signal to the measurement module. The measurement module 232 measures a sound pressure level of the sound output from the earphone 200 based on the digital signal. The measurement module 232 outputs the measured sound pressure level to the frequency characteristic data generation module 233. The frequency characteristic data generation module 233 generates frequency characteristic data 234 based on the sound pressure level.

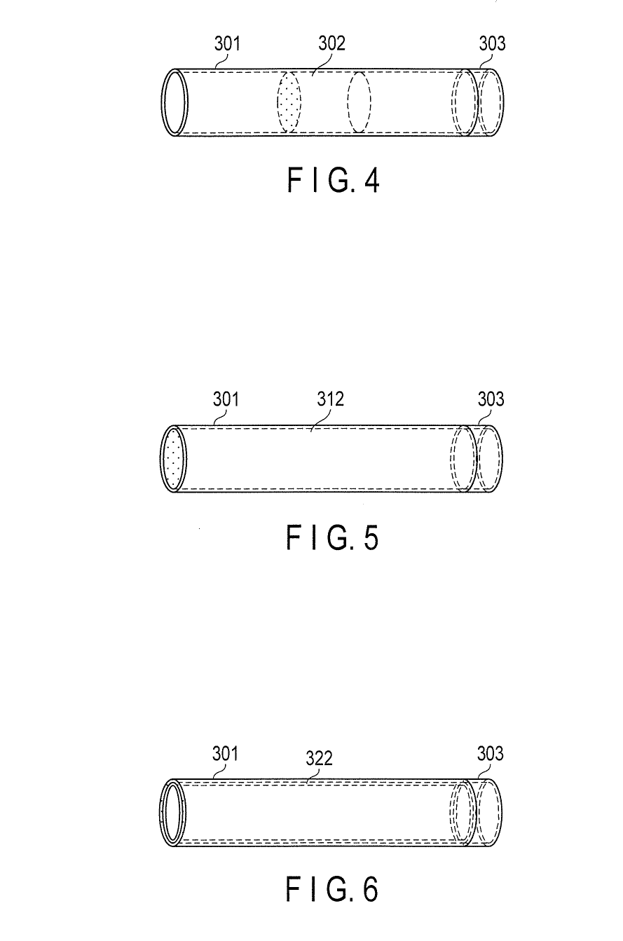

The adapter 210 is used to artificially reproduce sound that is transmitted to the eardrum via the external auditory canal. The configuration of the adapter 210 is explained with reference to FIG. 4. The adapter 210 includes a tube 301, sound-absorbing material 302, packing 303 and the like.

The tube 301 is formed of resin of a cylindrical form, for example, and is a linear form such as a water pipe or gas tube. The tube 301 includes a first port into which the earpiece of the earphone 200 is inserted and to which sound output from the earphone 200 is input and a second port from which sound input via the first port is output.

The important thing of the adapter 210 is the volume of the tube 301. It is proved based on the experiments that unnatural resonance occurs if the volume between the earphone 200 and the microphone 113 is excessively small. On the other hand, if the volume is excessively large, there occurs a problem that sound is attenuated while the sound is being transmitted from the earphone 200 to the microphone 113 and the signal-to-noise ratio of the measurement signal is lowered. It is proved based on the experiments that the adequate volume of the tube 301 is approximately equal to the volume of the external auditory canal of a human being.

Next, the sound-absorbing material 302 is explained. If the tube having substantially the same volume as that of the external auditory canal is used, resonance caused by the length of the tube occurs and obstructs measurement. In order to suppress the resonance, a sound-absorbing material is inserted into the tube. The sound-absorbing material is formed of felt, for example, is formed of a material having an effect of reducing sound transmission efficiency and is effective to prevent occurrence of the resonance. As shown in FIG. 4, it is effective to set the position in which the sound-absorbing material 302 is arranged in a position near the center of the tube. This is because air most violently vibrates in the position near the central portion. As shown in FIG. 5, a sound-absorbing material 312 may be filled in the entire portion of the tube 301. Further, as shown in FIG. 6, a material 322 having a sound-absorbing property may be attached to the inner surface of the tube 301. Additionally, the tube and sound-absorbing material can be formed of the same material having a sound-absorbing property.

Next, the packing 303 is explained. The packing 303 is used to prevent a gap from being formed between the adapter and the device when the adapter 210 is pressed against a portion near the microphone 113 and is effectively formed in an O-ring form. Since the object of the packing 303 is to cover the gap, the packing can be arranged on the device side and the packing can be omitted when the device itself is formed of a soft material and the airtight state can be attained without using the packing.

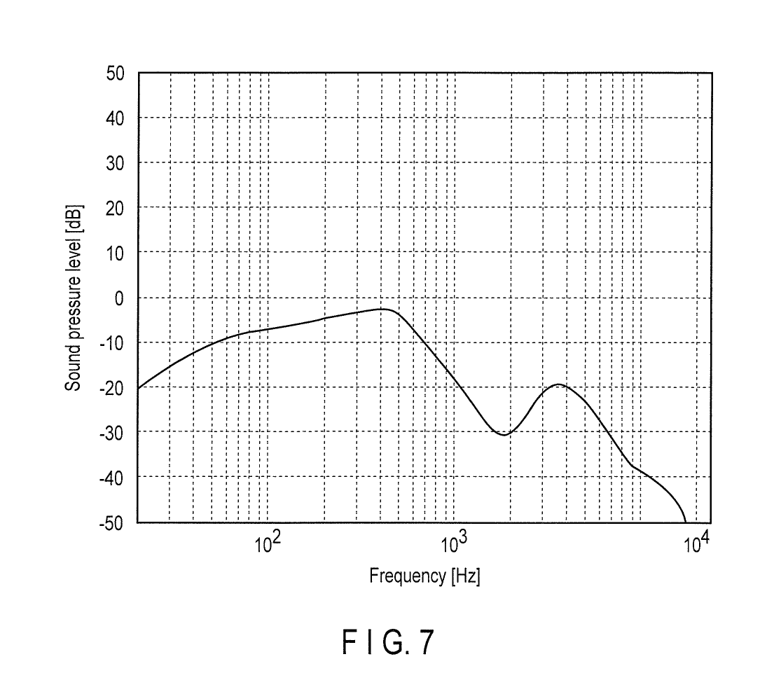

FIG. 7 shows the frequency characteristic of sound output from the earphone 200 and acquired by means of the microphone 113 via the adapter.

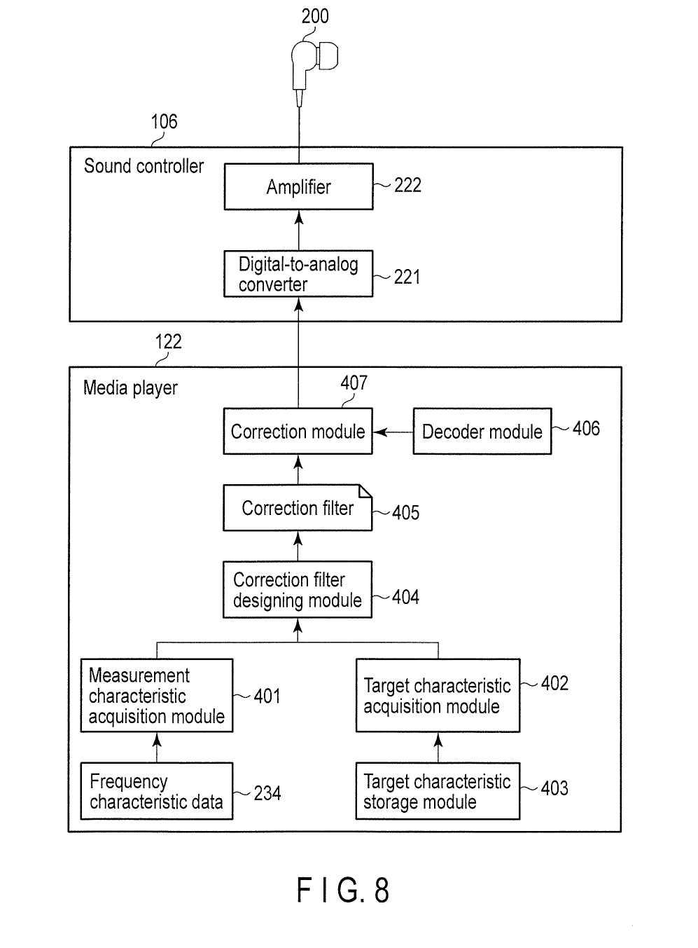

Next, the function of the media player using the measured frequency characteristic of the earphone 200 is explained. The playback function of the media player has a correction function of correcting sound output from the earphone 200 to have a target frequency characteristic based on the measured frequency characteristic of the earphone 200. Next, the correction function of the media player is explained with reference to FIG. 8.

As shown in FIG. 8, the media player includes a measurement characteristic acquisition module 401, target characteristic acquisition module 402, correction filter designing module 404, decoder module 406, correction module 407 and the like.

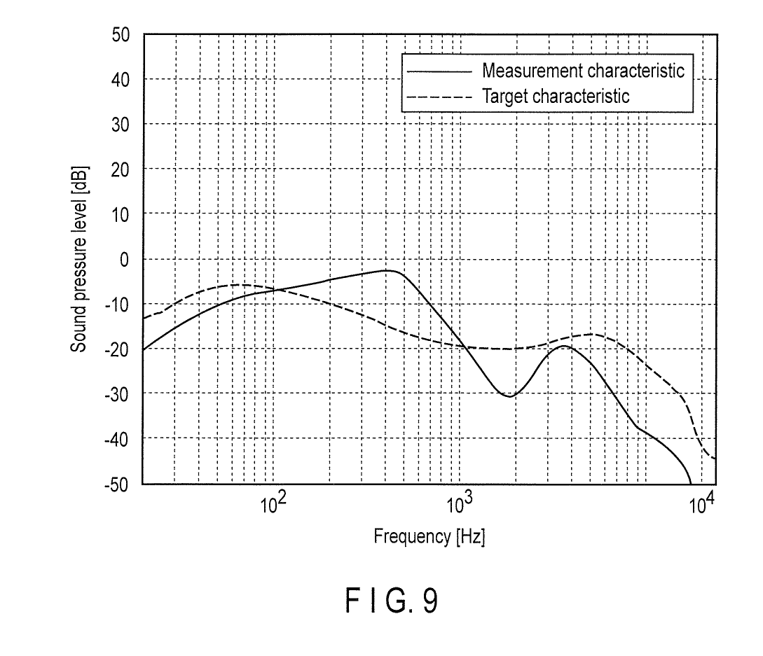

The measurement characteristic acquisition module 401 acquires frequency characteristic data 234 generated by the frequency characteristic data generation module 233. The target characteristic acquisition module 402 acquires target characteristic data indicating a target frequency characteristic (that is hereinafter referred to as a target characteristic) of sound output from the earphone 200 and reaching the eardrum from a target characteristic storage module 403. For example, in the target characteristic storage module 403, a plurality of target characteristic data items are stored. One of the plural target characteristic data items indicates an ideal frequency characteristic, for example. Further, a plurality of different target characteristic data items correspond to a plurality of music genres. One example of the frequency characteristic indicated by the target characteristic data is shown in FIG. 9. The target characteristic acquisition module 402 acquires one of target characteristic data items selected by the user from a plurality of target characteristic data items stored in the target characteristic storage module 403.

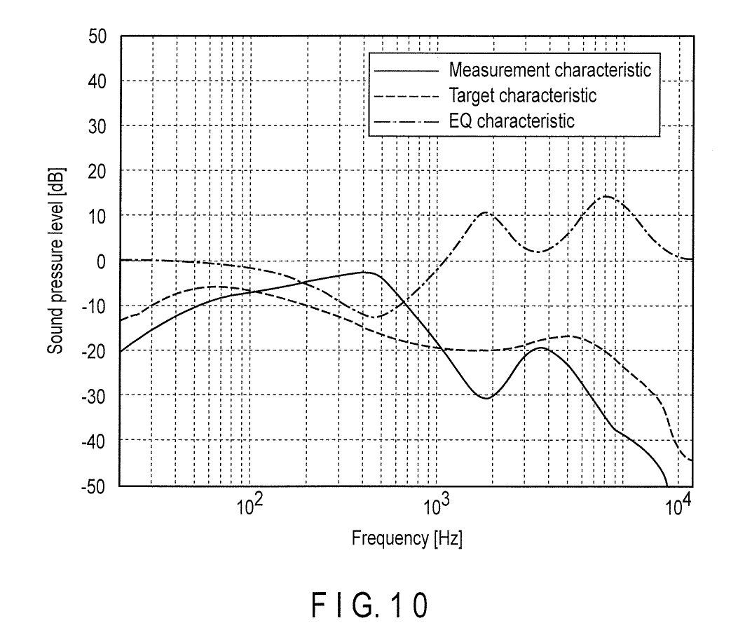

The correction filter designing module 404 designs a correction filter (correction data) 405 used for setting sound output from the earphone 200 and reaching the eardrum closer to the target characteristic based on the target characteristic data and frequency characteristic data. The frequency characteristic indicated by the correction filter 405 is shown in FIG. 10. For example, the correction filter 405 has parameters used in a general parametric equalizer. The parameters used in the parametric equalizer are a frequency set at the center, the bandwidth to be adjusted and volume.

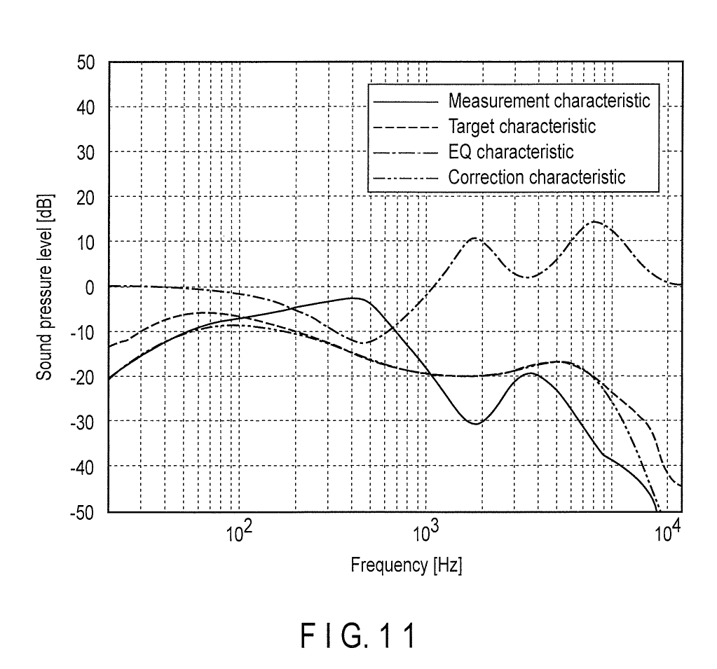

The decoder module 406 decodes data encoded in a compression format such as MP3 to generate audio data. The correction module 407 corrects audio data based on a correction filter formed by the correction filter designing module 404. The corrected audio data is input to the digital-to-analog converter 221. The digital-to-analog converter 221 converts the audio data to an electrical signal and outputs the converted electrical signal to the amplifier 222. The amplifier 222 amplifies the electrical signal and outputs the amplified electrical signal to the earphone 200. In FIG. 11, the frequency characteristic (correction characteristic) of sound output from the earphone 200 is shown. As shown in FIG. 11, it is understood that the correction characteristic substantially coincides with the target characteristic.

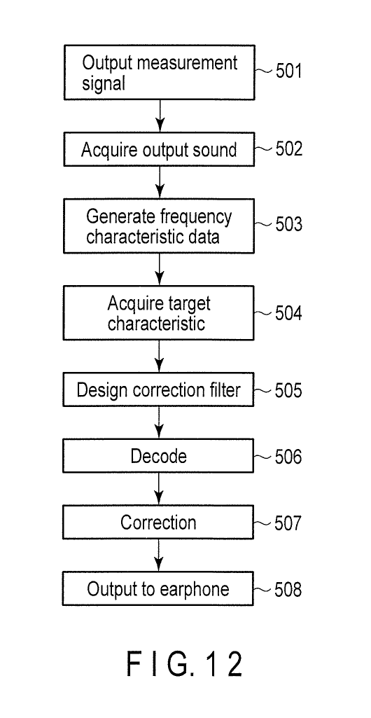

Next, the process of measuring the frequency characteristic of sound output from the earphone 200 and correcting the sound output from the earphone 200 based on the measured frequency characteristic is explained with reference to the flowchart of FIG. 12.

The measurement signal output module 231 outputs a measurement signal to the sound controller 106 to output measured sound from the earphone 200 (block 501). The sound output from the earphone 200 is acquired by the microphone 113 via the adapter 210 (block 502). The thus acquired sound is output to the measurement module 232. The measurement module 232 measures the frequency characteristic of sound and outputs the measurement result to the frequency characteristic data generation module 233. The frequency characteristic data generation module 233 generates frequency characteristic data (block 503).

The target characteristic acquisition module 402 acquires target characteristic data from the target characteristic storage module 403 (block 504). The correction filter designing module 404 designs a correction filter 405 based on the frequency characteristic data 234 and target characteristic data (block 505).

The decoder module 406 decodes music data that is compression-coded (block 506). The correction module 407 corrects the decoded music data based on the correction filter 405 (block 507). The correction module 407 outputs the corrected music data to the sound controller 106. The sound controller 106 converts the music data to a music signal, amplifies the converted music signal and outputs the amplified music signal to the earphone 200 (block 508).

It is possible to perform a process from the block 501 to the block 505, store parameters of the designed correction filter and read the parameters at the music playback time to perform a process from the block 506. The characteristic of the earphone is not greatly varied. Therefore, if the first half of the above block is once performed and the parameters of the correction filter are previously acquired, then time and effort for the measurement can be omitted by using the parameters after this.

According to this embodiment, when the user uses the earphone 200 to listen to sound, the sound becomes approximately similar to sound obtained by means of an ideal earphone 200. Therefore, for example, when music is played back, the user can enjoy the music with high quality. Further, the user can easily correct the characteristic of the earphone 200 even if the earphone 200 with low cost and poor characteristic is used.

The coefficient of the correction filter is designed by comparing the measured frequency characteristic of the earphone with the characteristic of an ideal earphone. This is equivalent to design the filter to fill the difference between the characteristics of the two earphones. Therefore, if the same variation occurs in the two characteristics, the variation does not occur in the difference. In this embodiment, the sound-absorbing material is provided in the adapter, but the sound-absorbing material can be omitted. Resonance caused by the length of the tube will occur due to omission, but no variation occurs in the difference between the characteristics required for correction if resonance occurs at the same frequency with respect to the two earphones. In practice, however, the resonance frequency may slightly vary due to a difference in the shape of the earphone and the position of the sound source unit in the earphone and a case wherein a slight correction error occurs near the resonance frequency may be considered. Therefore, in the characteristic near the resonance frequency, it is effective to take the countermeasure of more strongly smoothing a band in a frequency direction than another band and limiting the maximum value of a correction amount and perform a process of reducing the disturbance in the characteristic caused by a deviation in the resonance frequency.

### Second Embodiment

In the first embodiment, the configuration of measuring frequency characteristic data of the earphone 200 by means of the computer is explained. In the present embodiment, however, the configuration of acquiring frequency characteristic data of an earphone 200 from a server on a network is explained.

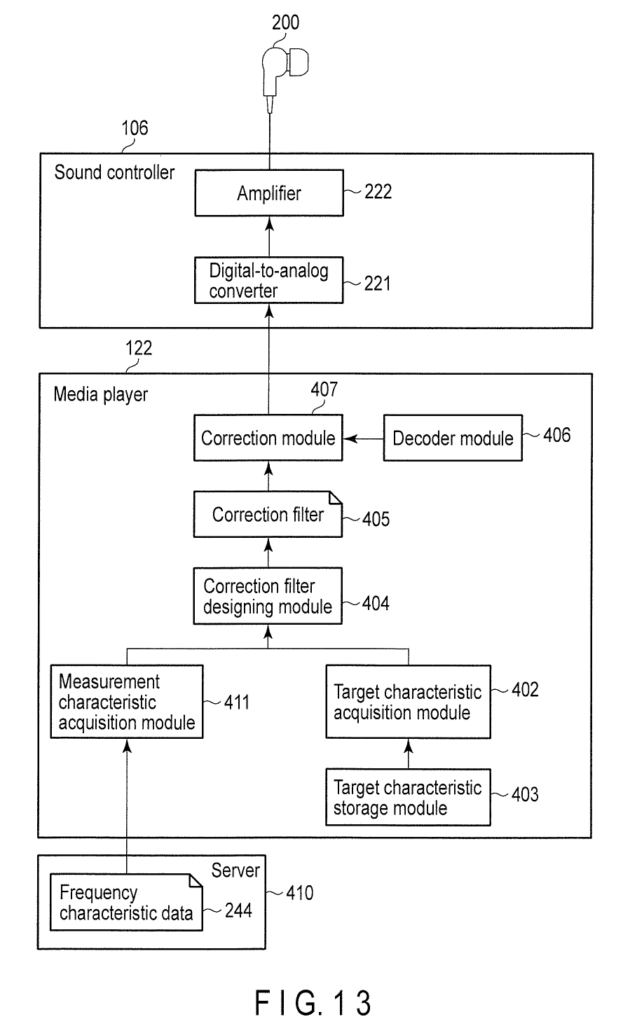

FIG. 13 is a block diagram showing the configuration of a media player of a playback apparatus of a second embodiment. As shown in FIG. 13, a media player 122 includes a measurement characteristic acquisition module 411, target characteristic acquisition module 402, correction filter designing module 404, decoder module 406, correction module 407 and the like.

The measurement characteristic acquisition module 411 acquires frequency characteristic data 244 from a server 410 on the network. The frequency characteristic data 244 is data provided from the manufacturing maker of the earphone 200. The frequency characteristic data 244 is not data obtained by directly measuring the frequency characteristic of the earphone 200. The frequency characteristic data 244 is a frequency characteristic obtained by measuring the same model as the earphone 200. Since the frequency characteristic data 244 is the frequency characteristic of the same model, the same effect as that of the first embodiment can be achieved.

The other configuration of the media player 122 is the same as that of the first embodiment, and therefore, the explanation thereof is omitted.

### Third Embodiment

In the first embodiment, the frequency characteristic of sound output from the earphone is measured by means of the microphone provided on the computer. In the present embodiment, however, the configuration having a microphone provided on an adapter is explained.

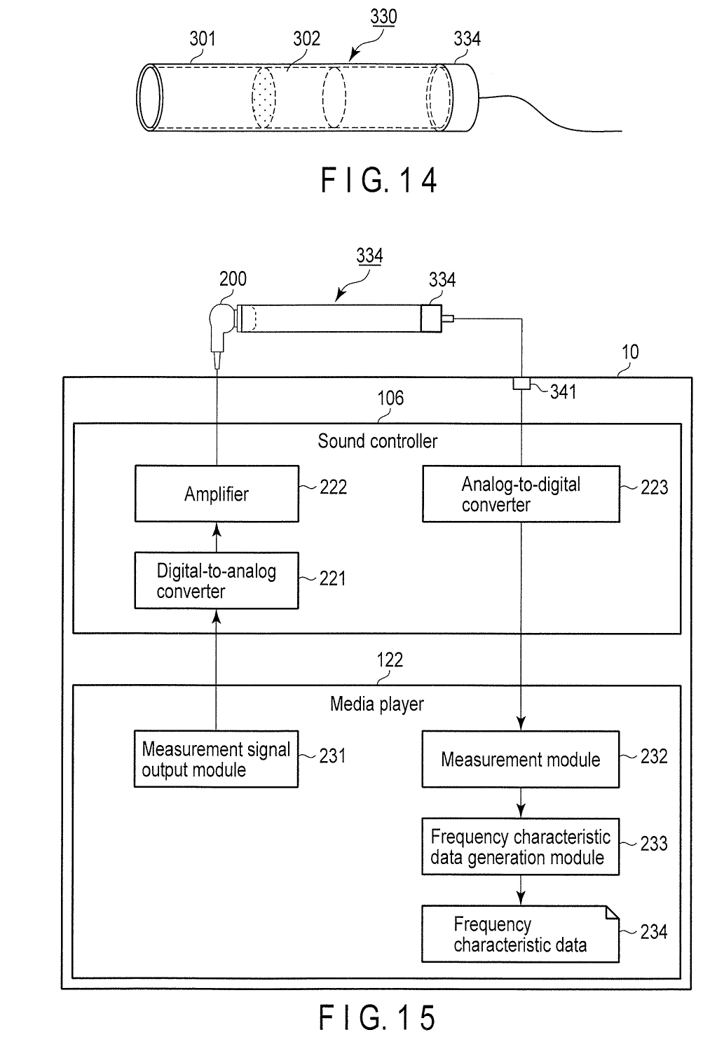

FIG. 14 is a view showing the configuration of an adapter of a third embodiment. As shown in FIG. 14, an adapter 330 includes a tube 301, sound-absorbing material 302, microphone 334 and the like. The microphone 334 is mounted on the bottom portion of the tube 301.

The configuration for measuring the frequency characteristic of an earphone of a media player of the third embodiment is explained with reference to the block diagram of FIG. 15. A signal collected by the microphone 334 is transmitted to a microphone input terminal 341 provided on a computer 10 as an analog signal, for example. The analog signal input to the microphone input terminal 341 is input to an analog-to-digital converter 223. The analog-to-digital converter 223 converts the input analog signal to digital data and outputs the digital data to a measurement module 232.

The measurement that is not influenced by the characteristic of the microphone contained in the computer 10 can be made by providing the microphone 334 in the adapter 330. Further, even if the user has a plurality of devices, the measurement result of the respective devices can be commonly used. Additionally, it is possible to use the same in a terminal that does not have a built-in microphone.

For example, the analog signal can be input via a line input terminal by amplifying the analog signal to a line level by means of an amplifier. Further, if the microphone 334 is a digital microphone and an output of the microphone 334 can be taken out as a digital signal, an input to the device becomes a digital input.

According to this embodiment, the measurement that is not influenced by the input characteristics of the microphones that are different for respective devices can be made by providing the microphone in the adapter. Further, the operation of pressing the adapter against the microphone becomes unnecessary at the measurement time and it becomes unnecessary to provide packing on the adapter 330.

### Fourth Embodiment

In the first embodiment, the output sound of the earphone is acquired via the adapter by means of the microphone 113. In the present embodiment, output sound of an earphone is directly acquired by means of a microphone 113.

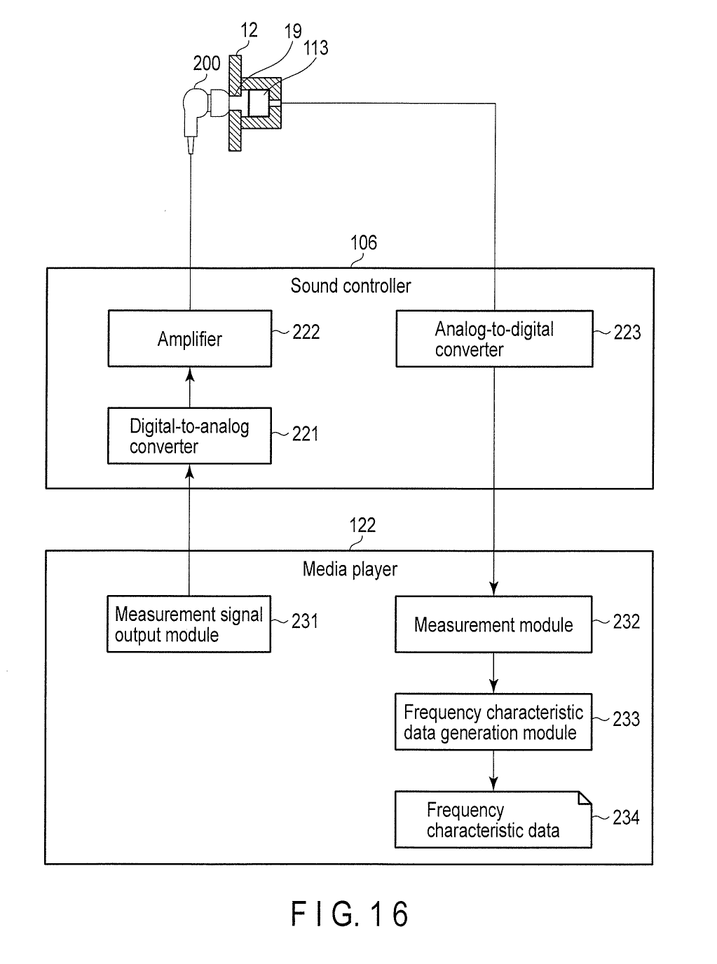

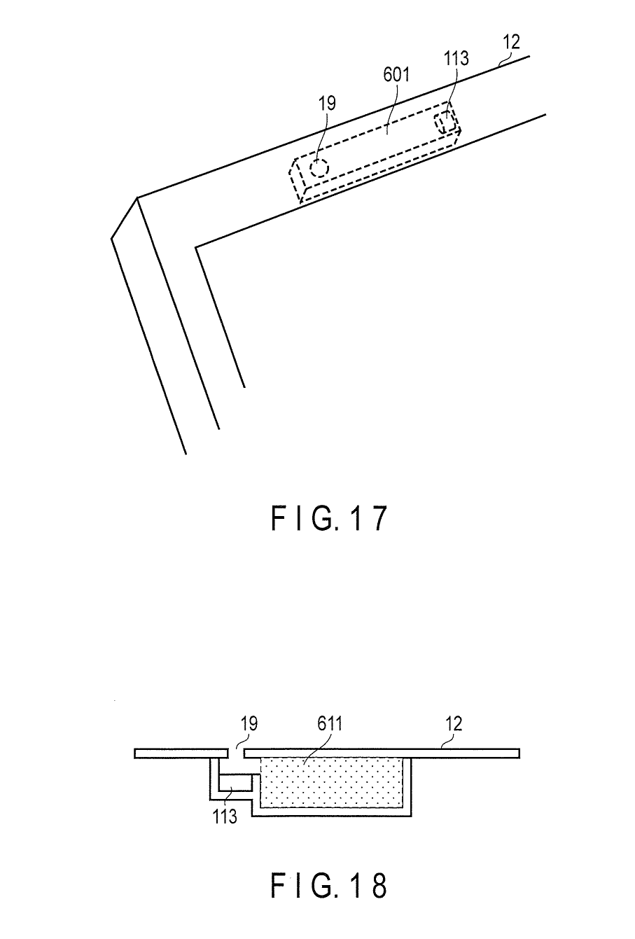

FIG. 16 shows an example in which output sound of the earphone is directly acquired by means of the microphone 113. Generally, the microphone 113 is mounted on a rear surface directly opposite to the surface of a device in which a hole is formed. If an earphone 200 is directly pressed against the microphone, a sufficiently large space cannot be provided and unnecessary resonance may occur. Therefore, the configuration in which a space corresponding to an adapter is provided in a display unit 12 may be considered. FIG. 17 shows an example in which a space corresponding to the adapter is provided in the display unit 12.

As shown in FIG. 17, a space 601 is formed in the display unit 12. A microphone port 19 against which the earphone is pressed and a microphone 113 that receives a measurement signal output from the earphone are provided in the space 601.

FIG. 18 shows a modification. Generally, the microphone is mounted on a rear surface directly opposite to the surface of a device in which a hole is formed. However, an extra space is not provided to acquire a preferable sound-absorbing characteristic in a normal case. When the earphone is directly pressed against the microphone, a sufficiently large space cannot be provided and an acoustic load that is different from that when the earphone is mounted on the ear may be applied to a transducer of the earphone and, as a result, the characteristic of the measurement result may become greatly different. Therefore, it is considered to provide the configuration in which a space corresponding to the adapter is provided in the device itself.

FIG. 18 shows an example in which a microphone is arranged directly below a sound-collecting hole to attain the normal sound-collecting performance. As shown in FIG. 18, a microphone 113 is provided directly below a microphone port 19. In a space on the right side of the earphone 200, a sound-absorbing material 611 is provided. If the sound-absorbing material 611 is provided in the space formed to adequately set the acoustic load when the characteristic of the earphone is measured, occurrence of the standing wave is suppressed and the frequency characteristic is not disturbed at the normal sound-collecting time and at the earphone characteristic measurement time. Various shapes of the space can be considered and circular and triangular spaces may be used. The important thing is to provide the volume corresponding to that of the external auditory canal. Further, occurrence of resonance can be suppressed by using the sound-absorbing material.

### Fifth Embodiment

In a mobile audio player, a desired correction filter cannot be used. In the present embodiment, an example in which data obtained by using the correction filter with respect to the mobile audio player is output is explained.

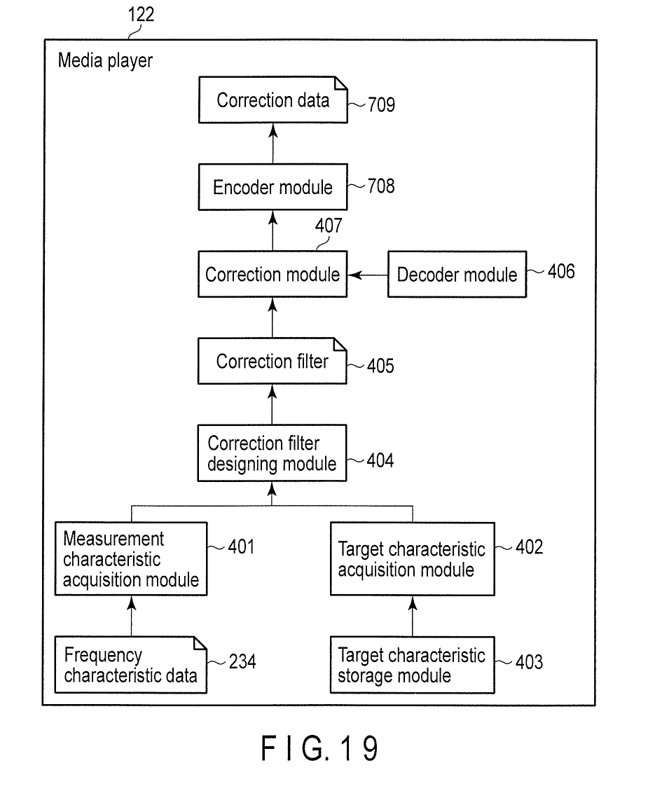

The configuration of a correction function of a media player (audio data correction device) is explained with reference to FIG. 19. As shown in FIG. 19, a media player 122 includes a measurement characteristic acquisition module 401, target characteristic acquisition module 402, correction filter designing module 404, decoder module 406, correction module 407, encoder module 708 and the like. The configuration of the measurement characteristic acquisition module 401, target characteristic acquisition module 402, correction filter designing module 404, decoder module 406 and correction module 407 is the same as that of the first embodiment.

The correction module 407 outputs data corrected by means of the correction filter 405 to the encoder module 708. The encoder module 708 encodes the corrected data and outputs compression-coded correction data 709.

Sound output from the earphone at the playback time of the correction data 709 becomes corrected sound by transferring the correction data 709 to the mobile audio player.

In the above embodiments, the earphone is explained as an example, but a stereo phone can be used instead of the earphone.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A playback apparatus comprising:
a generator configured to generate correction data used for correcting a frequency characteristic of sound output from a headphone based on first data and second data, the first data indicating the frequency characteristic of sound output from the headphone, and the second data indicating a target frequency characteristic;
a corrector configured to correct audio data based on the correction data; and
an audio signal output module configured to output an audio signal based on the corrected audio data to the headphone.

2. The apparatus of claim 1, further comprising:
a measurement signal output module configured to output a measurement signal to the audio signal output module;
a sound data acquisition module configured to acquire sound data output from the headphone based on the measurement signal; and
a second generator configured to generate the first data based on the acquired sound data.

3. The apparatus of claim 1, wherein the sound data acquisition module is configured to acquire the sound data corresponding to sound output from the headphone and input to a microphone via an adapter, and
the adapter comprises a tube comprising a first port to which sound output from the headphone is input, a second port that outputs the input sound from the other end, and substantially a same volume as that of an external auditory canal of a human being.

4. The apparatus of claim 3, wherein the adapter comprises a sound-absorbing material in the tube.

5. The apparatus of claim 4, wherein the sound-absorbing material is provided in a central portion of the tube.

6. The apparatus of claim 3, wherein the adapter and the microphone are integrally formed.

7. The apparatus of claim 1, further comprising an acquisition module configured to acquire the first data from a server computer connected to a network.

8. The apparatus of claim 1, further comprising:
a storage module configured to store third data items indicating target frequency characteristics; and
a selector configured to select the second data from the third data items.

9. The apparatus of claim 8, wherein the third data items correspond to music genres.

10. The apparatus of claim 1, wherein the corrector is a parametric equalizer.

11. An audio data correction apparatus comprising:
an acquisition module configured to acquire first data indicating a frequency characteristic of sound output from a headphone;
a correction data generator configured to generate correction data used for correcting the frequency characteristic of sound output from the headphone based on the first data and second data indicating a target frequency characteristic of sound; and
an audio data generator configured to generate first audio data by correcting second audio data based on the correction data.

12. A playback method comprising:
generating correction data used for correcting a frequency characteristic of sound output from a headphone based on first data and second data, the first data indicating the frequency characteristic of sound output from the headphone, and the second data indicating a target frequency characteristic,
correcting audio data based on the correction data, and
outputting an electrical signal based on the corrected audio data to the headphone.
